(19) United States
(12) Patent Application Publication
(10) Pub. No.: US 2010/0150768 A1
(43) Pub. Date: Jun. 17, 2010

(54) METHOD FOR PRODUCING METAL POWDER FOR DUST CORE AND METHOD FOR MANUFACTURING DUST CORE

(75) Inventors: Akira Fujita, Tokyo (JP); Tatsuhiko Hiratani, Tokyo (JP); Toshio Maetani, Tokyo (JP)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: JFE STEEL CORPORATION, Tokyo (JP)

(21) Appl. No.: 12/600,923

(22) PCT Filed: May 26, 2008
(86) PCT No.: PCT/JP2008/060092

§ 371 Date: Nov. 19, 2009

(30) Foreign Application Priority Data
May 31, 2007 (JP) 2007-145883

(51) Int. Cl. B22F 3/10; B05D 7/14; B22F 3/02; B05D 3/00

(52) U.S. Cl. 419/10; 427/216; 419/66

(57) ABSTRACT

A pure iron powder of a diameter of 10 to 500 μm and a purity of 99% by mass or more is heated to a temperature in the range of 600 to 1400° C., and a Si-concentrated layer is formed in regions within a depth of 5 μm from the surfaces of the powder particles by gas-phase reaction at a temperature of that range. The average Si concentration in the regions within this depth is controlled in the range of 0.05% to 2% by mass. Thus, a dust core metal powder enhancing the adhesion of insulating material to the particle without degrading compressibility is produced. The resulting dust core maintains a high saturation magnetic flux density and exhibits a low iron loss.

### RELATED APPLICATIONS

This is a §371 of International Application No. PCT/JP2008/060092, with an international filing date of May 26, 2008 (WO 2008/149825 A1, published Dec. 11, 2008), which is based on Japanese Patent Application No. 2007-145883, filed May 31, 2007, the subject matter of which is incorporated by reference.

### TECHNICAL FIELD

This disclosure relates to a method for producing a metal powder for dust core (a dust core metal powder) suitably used for the magnetic cores of motors and transformers. The disclosure also relates to a method for manufacturing a dust core using the metal powder.

### BACKGROUND

Motors and transformers use so-called “soft” magnetic material as the magnetic core material. The soft magnetic material is easy to magnetize in a low magnetic field. The soft magnetic material for this use is required to have a high Curie temperature and other various properties, such as a low coercive force, a high magnetic permeability, a high saturation magnetic flux density, and a low core loss.

Soft magnetic materials satisfying these requirements are roughly classified as soft magnetic metals and soft magnetic oxides, and are used properly according to the frequency or the power.

Soft magnetic oxides such as by MnZn ferrite advantageously exhibit a low core loss even at high frequencies of more than 100 kHz because of their high electric resistance. However, the saturation magnetic flux density is undesirably low.

On the other hand, the use of soft magnetic metals is limited to low frequency regions because of their low electric resistances. However, soft magnetic metals have high saturation magnetic flux density and, accordingly, advantageously allow the conversion and transfer of high energy. For example, an electrical steel sheet, which is a typical soft magnetic metal, is used for the magnetic cores of high-power transformers or motors used in a commercial power frequency region.

The reason why the use of soft magnetic metal is limited to the low frequency region is that as the frequency is increased, eddy current occurs in the soft magnetic material and cause a loss to reduce the energy efficiency. To reduce the eddy current loss, a technique is applied in which a magnetic core is prepared as a stack of electrical steel sheets surface-treated by insulation coating. Particularly for the magnetic core of a transformer or motor driven at a higher frequency, the eddy current is reduced by reducing the thickness of the electrical steel sheets.

The electric resistance between the steel sheets can be improved by reducing the thickness of the steel sheets, however, there is a limit in increasing the electric resistance within the steel sheet. It is difficult to reduce the eddy current loss at high frequencies of more than 10 kHz.

Using a dust core has been proposed to solve this problem. The “dust core” refers to a magnetic core produced by compacting a magnetic powder, such as pure iron or soft magnetic alloy, containing a binder such as resin as required, into a desired shape with a die. In this instance, eddy current loss can be reduced even at higher frequencies by performing insulation treatment on the surfaces of the magnetic powder particles, because the magnetic powder can be insulated in a three-dimensional manner to increase the electric resistance more unlike the electrical steel sheet.

If the green density after compaction is low, however, the saturation magnetic flux density becomes low and the mechanical strength is reduced. This is disadvantageous in comparison with the use of electrical steel sheets. For the dust core used in a motor or a transformer, it is important how the compressibility and thereby the green density are increased. When the green density is increased by increasing the compaction pressure, plastic deformation occurs and increases strain. If a plastic strain is induced on a magnetic material, hysteresis loss causing losses other than eddy current loss is increased, and results in an increased loss.

This problem may be solved by heating the compact to a temperature of 600° C. or more to remove the strain. Such heat treatment can reduce the plastic strain. As the heat treatment temperature is increased, the strain is reduced and, thus, the hysteresis loss can be reduced. On the other hand, a higher heat treatment temperature causes the insulation coating on the surfaces of the powder particles to decompose or crystallize and, thus, results in a reduction of interparticle electric resistance and an increased eddy current loss.

If the adhesion between the insulating material and the particles is low, the insulation coating may peel off through compaction process in some cases, and the electric resistance is reduced at this time.

The insulation coating on the surfaces of the particles is required to have a high adhesion to the particles and a high heat resistance. For example, silicone resin and phosphates are proposed as an insulating material satisfying such requirements.

Japanese Unexamined Patent Application Publication No. 2003-142310 discloses that, when a certain amount or more of Si is present at least around the surfaces of the particles of soft magnetic metal powder (more specifically, when the average Si concentration in the regions with in 0.2 μm from the surfaces is at least 0.5% by weight), insulation treatment can be performed effectively, and that consequently, the resulting dust core exhibits high electric resistance. To prepare a soft magnetic metal powder containing Si segregates around the surfaces of the powder particles at a high concentration, Japanese Unexamined Patent Application Publication No. 2003-142310 also proposes that a molten alloy composition containing Si is water-atomized.

For manufacturing a high-silicon steel sheet, a method is conventionally known in which a steel sheet containing a small amount of Si is siliconized by a gas-phase reaction method. For example, a steel sheet allowing easy rolling containing less than 4% by mass of Si may be subjected to a reaction with SiCl₄ at a temperature of about 1000 to 1200° C. The reaction SiCl₄+5Fe→Fe₃Si+2FeCl₂ produces Fe₃Si on the surface of the steel sheet and further diffuses Si in the thickness direction. Thus, a high-silicon steel sheet exhibiting high magnetic properties and high magnetostriction properties can be produced.

Japanese Unexamined Patent Application Publication No. 11-87123 proposes to prepare a soft magnetic powder that can be used for the magnetic core of a power supply trans-former whose initial magnetic permeability is not reduced even at high frequencies of more than 10 kHz through such gas-phase reaction. This soft magnetic powder is an Fe-based alloy powder containing Si distributed such that the Si concentration in the surface regions within a depth of one-tenth of the particle size of the powder from the surfaces of the particles is higher than that in the regions having a thickness of one-tenth from the centers of the particles. By providing such a Si distribution, the surface region of the soft magnetic powder exhibits high electric resistance and high magnetic permeability because of its higher Si concentration, and the center of the particle exhibits high saturation magnetic flux density because of its low Si concentration. Thus, the magnetic permeability can be increased. The appropriate Si concentration in the surface region in this case is 2% to 25% by weight. For obtaining such a Si concentration gradient as the Si concentration in the surface region of the powder is higher than that in the center region, Japanese Unexamined Patent Application Publication No. 11-87123 proposes that pure iron powder is subjected to siliconizing in a mixed gas atmosphere containing SiCl₄ at a temperature of 600 to 900° C.

Incidentally, we have also applied techniques for controlling the Si concentration at the surface of the metal powder (Japanese Patent Application Nos. 2006-52490 and 2006-52509, described below).

Although the use of a molten alloy containing Si, as in the above-described Japanese Unexamined Patent Application Publication No. 2003-142310, often allows Si to segregate at a high concentration around the surfaces, it is very difficult to control the Si distribution precisely.

On the other hand, Japanese Unexamined Patent Application. Publication No. 11-87123 is expected to provide a method that can more precisely control the Si concentration around the surfaces than the method of Japanese Unexamined Patent Application Publication No. 2003-142310.

It is known that an alloy composition containing a large amount of Si, such as Fe—Si alloy or Sendust alloy (Fe—Si—Al alloy), is hard itself. Similarly, it is known that an electrical steel sheet containing 6.5% by mass of Si has superior magnetic properties, but is difficult to roll because of its hardness. To produce a high-silicon electrical steel sheet, accordingly, a low-silicon steel sheet is rolled, and then siliconized by gas-phase reaction.

When the gas-phase reaction method applied to electrical steel sheets was applied to a metal powder containing, for example, 2% by mass of Si, the Si penetrated and diffused into the powder in a relatively short time because powder has a larger specific surface than the steel sheet and is accordingly more reactive.

However, the powder containing a large amount of Si exhibits a low compressibility, and it is difficult to obtain a highly dense compact from such powder. In addition, to increase the density of the compact, a high pressure is required for compaction. Consequently, strain is notably increased.

However, the compressibility of the powder may be relatively improved by increasing the Si concentration in the surface region and reducing the Si concentration in the center region.

We have found that when Si is vapor-deposited on the surfaces of the particles by a gas-phase reaction method, a high-Si layer (Si-concentrated layer) can be formed at the surfaces by selecting a temperature range in which Si deposited on the surfaces of the particles slowly diffuses into the iron powder or selecting an iron powder containing a microstructure into which the Si diffuses slowly so that the distribution in Si concentration in the depth direction is controlled by selecting the reaction time (Japanese patent Application Nos. 2006-52490 and 2006-52509, filed in the Japanese Patent Office).

However, the treatment according to the above-described process may increase the thickness of the high-silicon layer to hinder the production of a high-density compact depending on the conditions, or may require high-pressure compaction for high green density.

Thus, it could be helpful to provide both a method for producing a dust core metal powder and a method for manufacturing a dust core using the dust core metal powder as a raw material.

### SUMMARY

We thus provide:
1. A method for producing a metal powder for dust core including: heating a pure iron powder of a diameter of 10 to 500 μm and a purity of 99% by mass or more to a temperature in the range of 600 to 1400° C.; and forming a Si-concentrated layer having a thickness of 5 μm or less from the surfaces of the powder particles by gas-phase reaction at a temperature of that range, wherein the average Si concentration in the regions within a depth of 5 μm from the surfaces is controlled to 0.05% or more and 2% or less by mass.

Preferably, the pure iron powder being the starting material has a mean particle size of 100 μm or more.
2. The method for producing a metal powder for dust core of the method of above 1, further including performing a treatment for insulation coating on the surface of the Si-concentrated layer.
3. A method for manufacturing a dust core including compacting the metal powder for dust core subjected to a treatment for insulation coating, produced by the method of above 2.
4. A method for manufacturing a dust core including compacting the metal powder for dust core subjected to a treatment for insulation coating, produced by the method of above 2, and heat-treating the compacted powder at a temperature in the range of 600 to 1000° C.

### DETAILED DESCRIPTION

The following advantages are imparted to the dust core metal powder by uniformly concentrating Si only in the surface region of the powder:
a green density increased without degrading the compressibility of the powder;
a high saturation magnetic flux density thus maintained; and
an electric insulation enhanced by increasing the binding between the insulating material and the powder particles.

As described above, the presence of an appropriate amount of Si in the surface regions of the metal powder enhances the effect of insulation treatment to produce a dust core having a high electric resistance. It is, however, difficult to obtain a high dust core density and a high magnetic flux density if the powder is made of an Fe—Si alloy as a whole, as in Japanese Unexamined Patent Application Publication No. 2003-142310. Even if the Si is concentrated only in the surface regions of the powder, an excessively larger thickness of Si leads to a degraded compressibility of the powder, and it becomes difficult to obtain a high dust core density and a high magnetic flux density.

We found that both a good compressibility and a high electric insulation can be achieved at one time by strictly controlling the thickness of the Si-concentrated layer formed in the surface regions of the iron powder particles.

Our methods will now be described in detail.

A pure iron powder containing 99% by mass or more of Fe is used as a raw material. The pure iron powder is highly pure and soft and, accordingly, has a high saturation magnetic flux density and a superior compressibility. The balance of the composition is impurities including, for example, less than 0.05% by mass of Si.

Our methods include a series of steps of: heating the pure iron powder to a temperature in a predetermined range; then reliably concentrating Si only in the surface regions of the iron powder by gas-phase reaction; subsequently applying insulation coating to the surfaces of the powder particles; compacting the powder into a desired shape of a magnetic core; and, preferably, further heat-treating the compact to remove strain.

Typical methods for manufacturing the pure iron powder include atomization, reduction of iron oxide powders, mechanical crushing, chemical decomposition and electrolytic precipitation.

Atomization is the method of producing a powder by pulverizing a molten metal into droplets, and gas atomization or water atomization may be applied. The gas atomization uses a gas as a fluid for pulverizing the molten metal, and the water atomization uses high-pressure water as the pulverizing fluid. Alternatively, centrifugal atomization may be applied which produces a powder by scattering the molten metal into airborne droplets by centrifugal force. While gas atomization and centrifugal atomization can produce substantially spherical powder by controlling the cooling of the molten metal, water atomization produces powder including particles having rather irregular shapes.

In the method of reducing iron oxide to produce pure iron powder, the shape and the particle size of the powder substantially depend on the shape and particle size of the iron oxide powder before reducing treatment. For example, industrially mass-produced iron oxide can be obtained by spray roasting or fluidized roasting of iron chloride produced by washing a steel sheet with an acid. The spray roasting produces fine iron oxide particles having irregular shapes, and the fluidized roasting produces relatively large spherical iron oxide particles. The iron powder produced by reducing the iron oxide powder also has the similar shape.

The method for manufacturing a dust core includes insulation coating treatment and compaction. For coating the surfaces of the powder particles with an insulation coating, it is preferable that the irregularity of the particle surfaces be reduced as much as possible. In view of filling a die with the powder for compaction, the particles are desirably in a shape having high flowability and favorable die filling property.

Accordingly, it is advantageous that the particles have a spherical shape. In view of mechanical strength after compaction, however, slightly deformed particles may be more suitable in some cases than spherical particles. Therefore, the shape of the particles can be selected according to the application. For particles having irregularity, the flowability and the die filling property can be enhanced by smoothing the surfaces of the particles. For example, the surfaces of the particles can be mechanically improved by colliding the particles from the directions opposing with each other in a gas flow.

If the iron powder includes particles with irregular shapes and has pores in the particles, as is often observed in the reduced iron powder, the density of the compact may not be increased. Consequently, the resulting dust core cannot have a saturation magnetic flux density as high as expected, and may increase the hysteresis loss. By mechanical crushing in a ball mill, jet mill or the like, in such a case, the iron powder can be pulverized into particles not having pores and the irregularity at the surfaces can be smoothed. Alternatively, levitation melting may be applied to produce almost spherical powder particles not having pores inside. In the levitation melting, powder having a large number of pores are suspended in an inert gas flow in a tube and heated with an induction coil wound around the periphery of the tube, and thus each particle of the powder is melted.

The particle size and its distribution of the powder are varied according to the process for producing the powder.

For producing a magnetic core for a motor or a transformer, compaction is necessary. In view of die filling property and compressibility, the particle size (diameter, the same will apply below) is desirably in the range of 10 to 500 μm. More specifically, if the powder includes fine particles of 10 μm or less in particle size, the flowability becomes low, and accordingly the die filling property is degraded. On the other hand, it is difficult for powder including particles of more than 500 μm in particle size to achieve a high green density even if the compaction pressure is increased. Also, the mechanical strength is degraded.

Any method described above can control the particle size distribution of the powder in a certain range. In the water atomization, for example, a powder having particle sizes in the rage of 10 to 1000 μm can be produced by varying the temperature of molten metal and the spraying pressure. In the reducing method, the particle size, while depending on the particle size of iron oxide, can be controlled in the range of 1 to 1000 μm according to the method for producing iron oxide. Thus, the process and conditions for producing the powder can be appropriately selected so that the powder can have particle size suitable to produce a desired dust core.

A technique for concentrating Si in the surface regions of the powder particles will now be described.

As described above, a method has been known in which a steel sheet containing a small amount of Si is siliconized by a gas-phase reaction method to produce a high silicon steel sheet. In this method, for example, a steel sheet allowing easy rolling containing less than 4% by mass of Si is subjected to a reaction with SiCl₄ at a temperature of about 1000 to 1200° C. The reaction:

SiCl₄+5Fe→Fe₃Si+2FeCl₂

produces Fe₃Si on the surface of the steel sheet and further diffuses Si in the thickness direction. Thus, a high Si steel sheet exhibiting high magnetic properties and high magnetostriction properties can be produced.

When this siliconizing method was applied to a metal powder containing, for example, 2% by mass of Si, however, the Si penetrated and diffused into the powder in a relatively short time and, consequently, the Si was not concentrated only in the surface regions of the powder, because powder has a larger specific surface than the steel sheet and, as a consequence, is more reactive. If the Si concentration is increased over a region from the surface of the powder to a certain depth, the particles become hard and the compressibility in the subsequent compaction step is degraded to reduce the green density, similar to the case where the high Si steel sheet becomes difficult to roll. Consequently, a high saturation magnetic flux density cannot be obtained.

In this regard, we previously found that the Si concentration in the depth direction can be controlled according to the reaction time by selecting a temperature at which Si deposited on the surfaces of the powder particles is diffused slowly into the iron powder, or by selecting an iron powder having a microstructure into which Si is diffused slowly, even if deposited by gas-phase reaction method. However, this method forms a thick Si-concentrated layer as well and, accordingly, a high green density may not be obtained, or a higher pressure may be required for compaction to obtain a high green density.

We conducted intensive research to solve this problem and found that two properties of high compressibility and high electric insulation can be satisfied by controlling the thickness of the Si-concentrated layers formed in the surface regions of the iron powder particles, by appropriately controlling the reaction temperature and further the reaction time so that the penetration and diffusion into the powder of Si deposited on the surfaces of the iron powder by gas-phase reaction are appropriately controlled.

A preferred Si-concentration method will now be described with reference to one example using SiCl₄ gas. However, it will be readily understood that the Si-concentration method is not limited to this.

Pure iron powder having a particle size of 10 to 500 μm is placed in a quartz container to form a layer having a thickness of 5 mm or less, preferably 3 mm or less, and heated at a temperature in the range of 600 to 1400°, preferably 700 to 1200° C., in a non-oxidizing atmosphere. Then, SiCl₄ gas or a mixture of a non-oxidizing gas and SiCl₄ gas is introduced to the powder in the container at a rate of 0.01 to 200 NL/min/kg (NL: volume (L) in standard conditions, in terms of SiCl₄ gas). More preferably, the introduction rate is 0.1 NL/min/kg or more. Preferably, it is 80 NL/min/kg or less. Still more preferably, it is 50 NL/min/kg or less. The non-oxidizing gas is not particularly limited, but is preferably argon, nitrogen or the like from the viewpoint of availability and easy control.

If the reaction temperature in this stage is less than 600° C., a large amount of impurities, such as iron chloride or soot, remaining during or after reaction may be deposited on the surfaces of the powder, and thus may negatively affect the subsequent steps. Preferably, the reaction temperature is 700° C. or more.

As the reaction temperature is increased, the reaction rate increases. However, pure iron changes from a ferrite phase to an austenite phase at 900° C. or more, and the Si diffusion rate is remarkably reduced. Therefore, the diffusion rate is low up to a temperature of 1400° C. being the upper limit of the range in which the austenite phase is present, and accordingly Si-concentrated layers can be formed only in the surface regions of the powder effectively. Preferably, the reaction temperature is 1200° C. or less.

As long as the temperature is in such a range, the Si-concentrated layer can be formed not exceeding a region within 5 μm from the surface by appropriately setting the reaction time. If the reaction temperature is high, the reaction time should be reduced. The reaction time is generally 1 to 5 minutes. It is however arbitrary to perform the treatment for 10 minutes or more (about 60 minutes or less) to form the Si-concentrated layer reliably when the reaction rate is set rather low (about 600 to 800° C.).

Thus, Si can be concentrated stably only in the surface regions within a depth of 5 μm from the surfaces of the powder.

If the thickness of the iron powder filled in the container is more than 5 mm, SiCl₄ gas cannot penetrate into the entire powder as it stands, and consequently Si cannot be vapor-deposited uniformly on all the surfaces of the powder. If a large amount of powder is treated, it is preferable that the powder be treated while being agitated so that nonuniform gas-phase reaction can be prevented. For agitating the powder, the container containing the powder may be rotated, or the powder may be stirred with a stirring blade or by introducing a mixture of a non-oxidizing gas and SiCl₄ gas to fluidize the powder.

Preferred Si sources other than SiCl₄ suitable to form the Si-concentrated layer by gas-phase reaction include substances produced by substituting another element or group for part or entirety of the Cl of SiCl₄, such as methyltrichlorosilane, trichlorosilane, dichlorosilane and silane. The silicon medium is preferably silicon tetrachloride or silicon tetrachloride whose chlorine has been partially or entirely replaced with hydrogen, from the viewpoint of cost efficiency and the characteristic of not easily leaving impurities (soot). In addition, it goes without saying that methods that can be applied to Si concentration treatment of an electrical steel sheet can be applied for the iron powder in principle.

The Si-concentrated layer formed in the surface regions of the powder preferably has a thickness of 0.01 μm or more. This is because in a Si-concentrated layer having a thickness of less than 0.01 μm, Si concentration (to a Si content of 0.05% by mass or more in the regions within a depth of 5 μm) is industrially difficult to achieve to the extent that insulation treatment can be performed effectively as intended. On the other hand, the thickness of the Si-concentrated layer formed in the surface regions of the powder must be 5 μm or less. The inner region under this thickness still has a composition before performing gas-phase reaction. Hence, the application of pure iron enhances the compressibility, and consequently increases the green density, thus achieving a high saturation magnetic flux density. If the thickness of the Si-concentrated layer is increased to more than 5 μm, the powder particles become hard to degrade the compressibility. Consequently, a high green density may not be obtained, or high-pressure compaction may be required to obtain a high green density.

In addition, the Si concentration in the regions of the Si-concentrated layer is required that the average Si concentration within a depth of 5 μm from the surfaces is in the range of 0.05% or more and 2% or less by mass. If the Si concentration is less than 0.05% by mass, the insulation treatment cannot be performed effectively as intended. If the Si concentration is more than 2% by mass, the surface region become hard to produce a difference in hardness from the inner region. Consequently, the powder cannot be uniformly compacted by compaction, and the green density is thus reduced. The inner region under the Si-concentrated layer, that is, the region deeper than the position at a depth of at least 5 μm from the surface, has the same composition as the pure iron before performing gas-phase reaction.

The reason why the particle size of the iron powder is limited has been described above from the viewpoint of flowability, die filling property, and compaction property. Powder having superior compressibility requires that the Si-concentrated layer be present within the regions of 5 μM from the surfaces of the powder, and that the inner region under the Si-concentrated layer be pure iron. In this instance, if the powder has a particle size of 10 μm, Si concentration reaches nearly the center of the powder and the powder becomes hard. If the powder includes larger particles, these larger particles have relatively high compressibility. Accordingly, when the powder is compacted, the green density can be increased as a whole. Accordingly, the mean particle size of the powder used for compaction is particularly preferably 100 μm or more. If the mean particle size is 100 μm or more, however, be aware that the average Si concentration in the regions within a depth of 5 μm from the surfaces tends to increase to more than 2%. It is preferable that the conditions for forming the Si-concentrated layer be more appropriately adjusted according to a preliminary experiment or a prediction model formulated from existing data.

The method of reducing iron oxide has been described as a process for preparing iron powder to be subjected to gas-phase reaction. In this method, the iron oxide is heated in a reducing atmosphere, such as in hydrogen gas, CO gas, or a mixture of hydrogen gas and CO gas. Optionally, after completion of the reduction reaction, the entirety of the system may be replaced with an inert gas atmosphere, and subsequently gas-phase reaction is performed by introducing a gas containing SiCl₄. This method allows a subsequent step without reducing the temperature of the furnace heated, and is thus advantageous in handling and cost efficiency.

Insulation coating treatment of the powder in which Si has been concentrated in the surface regions will now be described. A known insulation coating treatment other than that described below or known conditions other than the range for limitation described below may be arbitrarily applied.

For the use of the iron powder for magnetic components, such as the dust core, it is required that the magnetic properties be enhanced by performing insulation coating treatment on the powder particles to form insulating layers having a layer structure coating the surfaces of the particles to increase the electric resistance of the compact and reduce the eddy current loss.

Any material can be used as the material of the insulation coating without particular limitation, as long as it maintains the insulation property even after the powder is compacted into a desired shape. Examples of such a material include oxides of Al, Si, Mg, Ca, Mn, Zn, Ni, Fe, Ti, V, Bi, B, Mo, W, Na and K. In addition, magnetic oxides, such as spinel ferrite, and amorphous materials such as water glass may be used. Furthermore, a phosphate layer, a chromate layer or the like may be used. The phosphate layer may contain boric acid or Mg. Phosphate compounds may also be used as the insulating material, such as aluminum phosphate, zinc phosphate, calcium phosphate and iron phosphate. Organic resins may be used, such as epoxy resin, phenol resin, silicone resin and polyimide resin.

To enhance the adhesion of the insulating material to the surfaces of the iron powder particles, or to enhance the uniformity of the insulating layer, a surfactant or a silane coupling agent may be added to the insulating layer or its raw material. Preferably, the surfactant or silane coupling agent content in the entire insulating layer is in the range of 0.001% to 1% by mass.

The proper thickness of the insulating layer formed by the insulation coating treatment can be appropriately set, depending on the particle size. The upper limit of the thickness can be selected in view of the insulation effect, and the lower limit of the thickness can be selected in view of the density of the compact (a sufficient density is required from the viewpoint of high magnetic flux density). In general, the thickness is preferably about 10 nm or more and about 10000 nm or less.

For forming the insulating layer on the surfaces of the iron powder particles, a known coating method can be appropriately applied. Applicable coating methods include a fluidized bed process, a dipping method, and a spraying method. Any process requires the step of drying the solvent in which the insulating material is dissolved, after or during the coating step. To enhance the adhesion between the insulating layer and the powder particles to prevent the insulating layer from separating from the powder particles by compaction, a reaction layer may be formed between the insulating layer and the surfaces of the powder particles. Preferably, the reaction layer may be formed by chemical conversion.

Compaction will now be described. A known powder metallurgy technique other than that described below or known conditions other than the range for limitation described below may be arbitrarily applied.

The powder (insulation-coated powder) including the particles whose surfaces are coated with the insulating layers by the above-described insulation coating treatment is compacted into a dust core. Before the compaction, a lubricant, such as metallic soap or amide-based wax, may be added to the powder if necessary. Preferably, the lubricant may be added in a proportion of 0.5 part by mass or less to 100 parts by mass of the powder. This is because if the lubricant content is increased, the density of the dust core is reduced.

Any known method can be applied for the compaction. Exemplary compaction methods include die compaction method performed at room temperature using a uniaxial press, a warm compaction method performed under warming, a die lubrication method performing compaction with a die lubricated, a warm die lubrication method performing die lubrication method under warming, high-pressure compaction performed under high pressure, and isostatic pressing.

Heat treatment for removing strain will now be described. A known heat treatment for removing strain other than that described below or known conditions other than the range for limitation described below may be arbitrarily applied.

A strain is induced on the compact for the dust core produced by the above-described compaction. Accordingly, the compact shows a high hysteresis loss. To remove strain to exhibit the inherent magnetic properties, heat treatment for removing strain must be performed. The heat treatment temperature is preferably in the range of about 600 to 1000° C. An excessively high heat treatment temperature enhances the effect of strain removal, but crystallizes or decomposes the insulation coating to lose the insulation effect. Consequently, the electric resistance is seriously reduced. Although heat treatment for a longer time is effective in removing strain, excessively long heat treatment seriously reduces the electric resistance as well. Accordingly, the heat treatment time is about 5 to 300 minutes, and more preferably about 10 to 120 minutes, in view of effectiveness and cost efficiency. It goes without saying that if the heat treatment is performed at an excessively low temperature or for an excessively short time, the strain cannot be removed sufficiently.

The resulting dust core may be subjected to gas-phase reaction treatment again to increase the Si concentration in the compact. This treatment can be performed by heating the dust core at a temperature in the range of 800 to 1000° C., depending on the size of the dust core and the heat resistance of the insulation coating, and thus doubles as heat treatment for removing strain. It goes without saying that a known Si concentration technique may be arbitrarily applied.

### EXAMPLES

### Example 1

Atomized pure iron powders (Fe content: 99.8% by mass, balance of impurities (Si: 0.01%)) having respective particle sizes shown in Table 1 were prepared as raw material powders. The mean particle size, the minimum particle size, and the maximum particle size of the powder were defined by the points where the integrated values of the accumulated particle size distribution measured with a laser scattered diffraction particle size distribution analyzer were 50%, 1% and 99%, respectively.

Each powder was filled in a quartz container with a thickness of 3 mm, and was heated at 600 to 1420° C. for 5 minutes in an argon gas atmosphere. Then, the powder was held at a predetermined temperature with silicon chloride gas flowing at a flow rate of 20 NL/min/kg for 1 to 10 minutes (No. 14, at 75 NL/min/kg for 30 minutes), and was further heated for 3 minutes after purging with argon gas. Thus, gas-phase reaction was performed.

The heating temperature and the heating time in SiCl₄ gas of each powder are shown in Table 1. Table 1 also shows the measurement results of the thickness of the Si-concentrated layer and the average Si concentration in the regions within a depth of 5 μm from the surfaces, after gas-phase reaction treatment. For the thickness of the Si-concentrated layer, sections of the particles (after polishing) were observed through a scanning electron microscope. The thickness of the Si-concentrated layer was determined using the position of the bump in the hardness profile between the Si-concentrated layer and the pure iron phase, and the results were verified by EPMA. The Si concentration in the Si-concentrated layer was quantitatively analyzed along a line segment from the surface to the center of the particle by EPMA. The integrated amounts of Si up to a little more than 5 μm from the surface were averaged in the depth direction. The average of five particles of the sample was used as central value.

Then, the surfaces of the resulting powder particles were coated with a silicone resin in the following manner. “SR2400” (™) (produced by Dow Corning Toray Co., Ltd.) was used as the silicone resin. The coating liquid was prepared by adjusting the silicone resin with xylene so that the resin content would be 5% by mass. The coating liquid was sprayed to the Si-concentrated powder fluidized in a tumbling fluidization coating system so that the resin content would be 0.05% by mass. After spraying, the fluidized state was held for 20 minutes for drying. Subsequently, heat treatment was performed at 250° C. in the air for 60 minutes to thermally cure the silicone resin, and thus a surface-insulated powder was obtained.

The resulting surface-insulated powder was compacted into a ring-shaped dust core (outer diameter: 38 mm, inner diameter: 25 mm, height: 6.2 mm) (for measuring magnetic properties). Before compaction, a suspension of 5% by mass zinc stearate in alcohol was applied onto the inner surface of the die to lubricate the die. Then, compaction was performed at a pressure of 900 MPa.

The resulting compact was subjected to heat treatment at 800° C. in a nitrogen atmosphere for 60 minutes.

The dust core was thus completed, and subjected to measurements for green density, magnetic flux density and specific resistance. The results are shown in Table 1 together.

The green density was calculated from the measured dimensions and weight of the dust core.

The specific resistance was measured at a current of 1 A by a four-terminal method.

For measuring the magnetic flux density (B₁₀ₖ), the dust core was provided with 100 turns of winding on the primary side and 20 turns of winding on the secondary side, and was subjected to measurement with a DC magnetometer at a magnetization force of 10 kA/m.

TABLE 1

| | | | | | | Si-con- | Average Si | | | | |
|---|---|---|---|---|---|---|---|---|---|---|---|
| | Mean | Minimum | Maximum | | | centrated | concentration | | Magnetic | | |
| | particle | particle | particle | Heating | Heating time | Layer | in surface | Green | flux | Specific | |
| | size | size | size | temp. | (in SiCl₄ gas) | thickness | regions* | density | density | Resistance | |
| No. | (μm) | (μm) | (μm) | (° C.) | (° C.) | (μm) | (mass %) | (Mg/m³) | B₁₀ₖ (T) | (μΩm) | Remarks |
| 1 | 150 | 90 | 300 | 675 | 10 | 1.8 | 1.0 | 7.49 | 1.52 | 37 | Example 1 |
| 2 | 220 | 45 | 450 | 800 | 7 | 4.8 | 1.9 | 7.48 | 1.51 | 78 | Example 2 |
| 3 | 300 | 175 | 485 | 880 | 1 | 2.2 | 1.8 | 7.52 | 1.53 | 65 | Example 3 |
| 4 | 110 | 15 | 380 | 700 | 5 | 1.1 | 1.2 | 7.59 | 1.51 | 26 | Example 4 |
| 5 | 150 | 90 | 300 | 920 | 7 | 0.3 | 0.6 | 7.50 | 1.52 | 55 | Example 5 |
| 6 | 150 | 90 | 300 | 1000 | 10 | 0.2 | 1.1 | 7.59 | 1.51 | 26 | Example 6 |
| 7 | 150 | 90 | 300 | 1200 | 8 | 0.3 | 1.3 | 7.50 | 1.51 | 67 | Example 7 |
| 8 | 150 | 90 | 300 | 1380 | 5 | 0.4 | 1.9 | 7.49 | 1.50 | 81 | Example 8 |
| 9 | 35 | 7.5 | 60 | 850 | 5 | 1.3 | 1.3 | 7.22 | 1.38 | 123 | Comparative |
| | | | | | | | | | | | Example 1 |
| 10 | 600 | 450 | 980 | 850 | 5 | 1.5 | 1.4 | 7.18 | 1.30 | 108 | Comparative |
| | | | | | | | | | | | Example 2 |
| 11 | 150 | 90 | 300 | 580 | 10 | 0.008 | 0.0 | 7.53 | 1.54 | 0.01 | Comparative |
| | | | | | | | | | | | Example 3 |
| 12 | 150 | 90 | 300 | 1420 | 5 | 0.6 | 2.8 | 7.39 | 1.40 | 145 | Comparative |
| | | | | | | | | | | | Example 4 |
| 13 | 90 | 12 | 190 | 700 | 10 | 2.1 | 1.6 | 7.42 | 1.45 | 230 | Example 9 |
| 14 | 150 | 90 | 300 | 700 | 30 | 4.0 | 1.9 | 7.54 | 1.52 | 80 | Example 10 |

*regions within a depth of 5 μm from surfaces

As shown in Table 1, in any powder subjected to gas-phase reaction treatment, a Si-concentrated layer was formed to an appropriate thickness at an appropriate concentration in the surface regions. The dust core made of such a powder had a superior green density, and exhibited a superior magnetic flux density and electric resistance.

### INDUSTRIAL APPLICABILITY

Our methods provide a dust core metal powder easy to insulate and exhibiting high saturation magnetic flux density.

The dust core metal powder can be compacted into a dust core having a high electric resistance and high green density. Thus, use of the dust core provides a motor, a transformer or the like having superior magnetic properties.

More specifically, an iron powder in which an appropriate amount of Si is concentrated only in the surface regions of the powder particles can be obtained by appropriately controlling the conditions of gas-phase reaction for vapor-depositing Si on the surfaces of the particles. Furthermore, the iron powder is then subjected to compaction and annealing after insulation coating treatment. The resulting dust core exhibits a high green density, a high magnetic flux density and a high electric resistance. Thus, a dust core for motors and transformers having superior magnetic properties can be produced at a low cost.

1. A method for producing a metal powder for dust core comprising: heating a pure iron powder of a diameter of 10 to 500 μm and a purity of 99% by mass or more to a temperature in the range of 600 to 1400° C.; and forming a Si-concentrated layer having a thickness of 5 μm or less from the surfaces of the powder particles by gas-phase reaction at a temperature of that range, wherein the average Si concentration in the regions within a depth of 5 μm from the surfaces is controlled to 0.05% or more and 2% or less by mass.

2. The method for producing a metal powder according to claim 1, wherein the pure iron powder has a mean particle size of 100 μm or more.

3. The method for producing a metal powder according to claim 1, further comprising performing a treatment for insulation coating on the surface of the Si-concentrated layer.

4. A method for manufacturing a dust core comprising: compacting the metal powder produced by the method as set forth in claim 3.

5. The method for manufacturing a dust core comprising: compacting the metal powder produced by the method as set forth in claim 3; and heat-treating the compacted powder at a temperature in the range of 600 to 1000° C.

6. The method for producing a metal powder according to claim 2, further comprising performing a treatment for insulation coating on the surface of the Si-concentrated layer.
